(19) United States
(12) Patent Application Publication
(10) Pub. No.: US 2008/0084429 A1
(43) Pub. Date: Apr. 10, 2008

(54) High performance image rendering for internet browser

(76) Inventor: Sherman Locke Wissinger, Somerville, MA (US)

Correspondence Address: Sherman Wissinger, 326 HIGHLAND AVE, SOMERVILLE, MA, 02144, US

(21) Appl. No.: 11/542,693

(22) Filed: Oct. 4, 2006

(51) Int. Cl. G09G 5/00

(52) U.S. Cl. 345/640

(57) ABSTRACT

A method for conveying and displaying a high-performance image in a standard web browser, via a pair of image data files in traditional formats which do not support such higher-performance individually, each downloaded by a web server in traditional manner and then re-combined via a software algorithm executed at the browser. Said high-performance features may include rendering the appearance of background transparency in and around opaque figures within the normal rectangular area of an image; variable semi-transparency; cropping (or retro-) transparency, and auto-shadowing of overlaid images.

Additionally, exploiting the infrastructure of the invention thus described, further means by which a single image, embedded in a group of images co-located within a shared display region, can be easily designated by a simple pointing device such as a computer mouse, even though said single image may appear substantially obscured by other irregularly-shaped images in the region.

### CROSS-REFERENCE TO SUPERCEDED PROVISIONAL APPLICATION

This application supercedes the provisional application, numbered 60/724,433, filed by the same inventor on Oct. 7, 2005 with formal changes in this application document, but no substantive changes to the invention.

### BACKGROUND OF THE INVENTION

This invention relates to the ongoing evolution of image rendering in web browsers. Within barely a decade, documents on the World Wide Web (“the Web”) have seen a dramatic evolution from being mostly text pages ornamented with occasional figures and drawings, to becoming primarily graphic presentations ornamented with occasional text. This evolution also included dramatically increased user interaction. The result of these two trends has been an increased importance of dynamic layering and un-layering of images co-located within a common region, and this leads to an inevitable demand for features collectively called “background transparency”.

In simplest form, background transparency is the feature which allows an image's array of pixels to appear as if there is an irregularly shaped opaque figure within its rectangular boundary, such that when this image is laid over another image, the non-opaque areas within the boundary do not appear, allowing parts of the underlying image to be visible.

The technology for implementing simple transparency for images displayed within a web browser has lagged far behind the technology for doing the same in more private computer environments, including personal computers and graphics workstations, mostly because technologies for web browsers evolved in an ad-hoc, market-driven manner.

While some web standards are beginning to emerge, there is growing demand for more sophisticated forms of image transparency, including semi-transparency which can vary irregularly throughout an image; “cropping transparency” which provides that an image's transparent pixels appear to erase (or “crop) pixels of one underlying image while allowing pixels of a further-underlying image to be visible; and “auto-shadowing” wherein dark, semi-transparent pixels of an overlaid image appear as a shadow upon a near-underlying image, yet are completely invisible where laid over a further-underlying image.

Cropping transparency and auto-shadowing require a ranking of multiple underlying images as to being “near” or “far” background. Such intelligence is not easily implemented via the standard web protocols, despite being more commonplace in private computer environments, and many browser users are familiar with the occasional inconvenience of updating browser plug-ins which provide this for specialized web content.

One of the most challenging browser tasks in the real world, demanding all of the features outlined above, is to support the imaging requirements of fashion garment retailing. Fashion retailers need to provide mixing of garment, mannequin and background images to provide a rich and realistic visual appearance in the browser as they attempt to migrate from their glossy print media which have been setting aesthetic standards for years in the field of graphic arts.

Thus it is natural that our descriptions here can be cast into examples of imagery for fashion retailing, and in fact, the present invention was inspired by the challenges of migrating fashion retail from the glossy page to the luminous browser.

### DESCRIPTION OF PRIOR ART

Digital images displayed in a browser have traditionally required special considerations and limitations to render transparent background pixels around the irregular edges of an opaque foreground figure: The irregular shapes of hats, blouses, jewelry, etc all place special demands on how these images may be superimposed realistically on one another and upon the image of a human body, and then further upon a background image such as a landscape.

Traditionally, background transparency has been provided on the Web via the Compuserve GIF image format. Pixels in a GIF image could be assigned a “transparency value” understood by all web browsers, indicating that pixels underlying such transparent GIF pixels should be displayed in place of those GIF pixels.

There is a serious deficiency in the GIF format: The non-transparent pixels may only be displayed from a palette of 255 colors, meaning that GIF images are rarely capable of rendering a photo-quality comparable to the more widely-used JPEG (or JPG) format. Although JPG images provide a palette of millions of colors, and are pervasive on the Web and in consumer digital cameras, they have no feature by which browsers can provide any type of transparency.

Thus, there were no traditional image formats for web browsers adequate for providing transparency features at the quality provided in the pages of glossy print media such as fashion magazines and catalogs.

Then, around 2005, websites began to use a new format known as PNG. Modern browsers now exploit this new format to render transparent backgrounds, as well as the semi-transparency Which provides the popular edge-shadows around the lower and right sides of images.

However, the PNG images are not optimal for certain applications on the Web. To begin with, web artists discovered that, when transparency is active in PNG format, the entire image can no longer be compressed in the way which has made imaging so available on the Web. Thus it is not unusual that a PNG image normally compressed into a 20-kilobyte file would be undesirably forced upward in file size to 100 kilobytes or larger if even a single pixel in the image were to be designated as transparent or semi-transparent.

Furthermore, there are a number of applications which need semi-transparency to behave differently towards different species of background image: The semi-transparent shadow of a hat should fall on a mannequin's face, but not on the sunset behind her, while, at the same time, the semi-transparent cloud of her wind-blown hair should blend equally to her face as well as the sunset. A PNG image cannot discriminate between these two co-existing cases.

### Vector Graphics

Throughout this application we use the term “image” to refer to a rectangular array of pixels, known more concisely as a “raster image”. We note that the most successful technology for implementing background transparency in browsers has been what is called the “vector image”. Vector images are actually compacted lists of commands to compose a complex image by drawing a series of primitive figures such as lines, curves or polygons, such that background transparency becomes a moot issue: Wherever a primitive figure is not drawn, the previous content remains visible, as if it were background.

Most browser users are familiar with the Shockwave or Flash plug-ins, offered by the Macromedia corporation, which render numerous animations and cartoons with excellent background transparency, but there has never been a vector-graphics technology offered for the browser which can provide the realism of raster images.

This is not for lack of trying, however, and a very eye-catching example of the fashion industry's best efforts with vector graphics may be seen in a pilot project for The Gap (garment retailers) on the Web at www.WatchMeChange.com. The mannequin dance moves are bravura, but the image quality of the garments has been insufficient to propel this technology into any useful component of The Gap's retail operations.

### SUMMARY OF THE INVENTION

This invention adds an integrated package of new features to images posted on the World Wide Web (“the Web”). All of these features primarily relate to how a web browser can better implement:
1. Transparent backgrounds which surround irregularly-shaped opaque figures within rectangular images
2. Semi-transparency as in the translucent quality of clouds or gossamer fabrics

However, this invention may be utilized for other image enhancements (summarized later in this disclosure) within a web browser.

This invention was originally developed to deliver enhanced performance for displaying combinations of garments worn on a virtual mannequin portrayed in fashion retail websites, though it is not limited to such applications. The irregular shapes of anatomy and garments do, however, facilitate our description of the performance enhancements provided by this invention. Hence the examples in this disclosure will be garment-oriented, usually involving pictures of a fashion model standing in front of some background landscape and wearing certain items of clothing.

This invention embodies an integrated package of two innovations, namely
1. A pair of sibling image files to produce the enhanced display of a single image, plus
2. Segregation of “near” vs. “far” background image-processing,

### However, the entire scope of this invention embodies additional innovations based on the synergy between the two.

This invention innovates the means for new, high-performance features in digital images using neither special browser plug-ins nor any image formats which would be novel to traditional browsers. We can now achieve these goals by dividing a basic image and its advanced features into a pair of sibling image files of traditional formats, sequentially downloaded by a traditional web server, and then re-combining them in the browser to achieve performance not normally available through the traditional formats.

Most of our summary here will focus on the rendering of background transparency, such that a figure in a “foreground” image (i.e. a fashion model or mannequin) appears to be in front of some scene portrayed in a “background” image. In such a context, there must be means by which undesired “transparent” pixels in the foreground image-rectangle are omitted so as to allow pixels from the background image to beshowing-throug.

Additionally, our summary will focus on a feature needed for realistic rendering of hair and items of lingerie: semi-transparency, being the best way to approximate the visual appearance of the gossamer fabrics or the cloud-like swirl of wind-blown hair.

We also note that the enhancements offered by the present invention are not very novel, from a functional viewpoint, in general computer science. Image overlays with semi-transparency and background transparency have been a staple of computer graphics for decades. However, it is the limited, arcane environment of the web browser which has been such an obstacle to advanced image processing on the Web, and the present invention relies on techniques which might be inefficient or inappropriate in other computer environments which are free of the web browser's limitations.

### Sibling Images and Modes of Transparency

The present invention innovates the idea that a high-quality image (usually a JPG image), once it has been downloaded from a web server and decoded into a pixel array in the browser, may have those pixels individually “marked” according to image data held in pixels received in a sibling image file. This sibling would typically be a GIF image, whose appearance resembles a silhouette copy of the first image: If the JPG image is of a portrait of a human face, then the GIF silhouette-image might appear as a colored rectangle of equal size, containing a central, solid area of some other color whose boundary outlines the hair, neck and shoulders.

This invention innovates that the pixels in this silhouette-image are not to be displayed, but rather used as a pixel-by-pixel map to add attributes their sibling pixels in the decoded JPG array regarding how the JPG pixels should be displayed vis-à-vis underlying pixels of background already visible in the browser window.

We refer to this sibling silhouette image as a “mask”, in keeping with traditions of actual physical cutout masks used in photographic arts. Data-arrays governing the behavior of digital images are sometimes called masks in computer arts, as well, yet we know of no instances of masks conveyed to Web browsers via conventional display-formatted files to render any features similar to those disclosed here.

To implement simplest transparency, we might use a strategy wherein every pure-blue pixel in the mask-image would be used to mark a corresponding JPG pixel to be treated as being transparent (i.e. allowing the underlying background pixel to be seen instead), while every pure-green pixel in the mask would designate its sibling JPG pixel as being opaque.

The term “simple transparency” helps us distinguish between four modes of transparency provided by this invention:

1. Simple Background Transparency is described in the previous paragraph and earlier parts of this application.

2. Semi-Transparency is the blending of color of background and foreground pixels. The blending factor may be constant across an entire image, but the mask may be composed so that the background/foreground blend varies irregularly through various parts of an image. We refer to this as “cloud transparency”, referring to the irregular opacity of a cloud.

3. Auto-Shadowing is a special case of cloud transparency, in which a swath of dark pixels in a foreground image may be marked as cloud-transparent, rendering an appearance of shadow cast upon the background pixels. The specialty of cloud transparency, however, is the stipulation that this synthetic shadowing will appear to fall only upon any near-background image(s) but not upon far-background image(s). “Near” vs. “far” backgrounds are described below.

4. Cropping (or “Retro-”) Transparency is a scheme by which a topmost image imposes transparency retroactively upon previous underlying images so that the bottom-most background image is newly revealed, appearing as if those intermediate images were cropped or trimmed when the topmost image was laid on. Example: Over-laying the image of a tight, body-fitting leather jacket upon an image of a woman wearing a billowing loose blouse—In order to maintain realism, as if the loose blouse were squeezed to fit within the tight jacket, blouse pixels outside the jacket's opaque shape must be retroactively rendered as transparent (i.e. cropped), so that the jacket appears not laid upon a blouse, but rather containing or compressing the blouse, all set against a background landscape.

Near-Background vs. Far-Background

Thus far, we have summarized a primary technique of the invention: Utilizing two sibling images in order to arbitrate the visibility of foreground pixels against background pixels in a single, final view. However, a second technique is required to optimally provide items #3 and #4 in the above list: Background images are to be distinguished as being either “near-background” or “far-background”.

This was nearly explicit in item #4: The loose blouse would be considered as near-background, while the landscape behind the mannequin is considered far-background. When the foreground image of a tight jacket is overlaid, it is the near-background blouse pixels which become cropped (retroactively transparent), so that the far-background landscape pixels will be visible tightly against the jacket's outline.

Dual backgrounds were also implicit in item #3 for auto-shadowing: Far-background should, generally speaking, never receive auto-shadowing. Example: A broad-brimmed hat should naturally cast a shadow across the face of the fashion model, but it would not be realistic for such a shadow to fall upon some landscape, such as an ocean sunset, behind her.

This invention innovates new ways to exploit image/mask features against these two species of background, but the actual techniques for accumulating and segregating these species are not part of this invention. Thus we elaborate on two issues:
1. How are multiple images, all to be overlaid in a single region, segregated and maintained as near vs. far background images while they are arriving from a web server? This is pertinent to the invention, though not claimed by it, and is briefly summarized in the following section.
2. How do we extend the scheme of simple transparency (arbitrated via sibling mask images previously described) to optimally implement the separate arbitration of near vs. far background images?

### Segregation of Near-Background and Far-Background Pixels

Regarding segregation and maintenance of near vs. far backgrounds, there are a number of possible schemes, depending on the needs of the entire application. The simplest of these would involve some stratagem by which image files could be explicitly designated as being of near or far type, but practical applications can often make better use of an implicit designation scheme. Possible implicit schemes may include:
1. Background considered as “far” by virtue of arriving first in a series of images which are sequenced according to apparent distance from the viewer's eye. Far background would arrive first, and the object closest to the viewer would be presented by the image arriving last in the series.
2. Far-background identified as a solid mono-chromatic array of pixels, generated prior to the arrival of any images from the web server (i.e. a “blank background”).
3. Far-background designated by some other feature of image processing in the application, such as wallpapering, a popular way in which an image is repeated edge-to-edge in rows and columns to form the backdrop to web graphics.

Far background generally has no transparency of its own and should be at least as large as the rectangle enclosing all subsequent foreground images, and it generally should not change its shape, size or content once it has arrived.

Near background, by contrast, is a more dynamic, cumulative concept. The first-arriving foreground image considers the far-background image to be its near-background as well. But this first foreground image might then become, itself, near background for the next arriving image. Likewise, a third foreground image would see a near-background which is the accumulation of the previous two foregrounds, and so forth such that the n^{th} foreground image sees a near-background which is the accumulation of images 1 . . . n−1 (with image 0 being the far-background). For example, an arriving foreground image of eyelids would consider previous images of rough-face and eyeballs to be near-background (because eyelids appear in front of rough-face and eyeballs), but these eyelids, themselves, would be accumulated into near-background upon the arrival of a foreground image of eyelashes or mascara.

Note that near-background may be retained as a collection of individual images, or it may be maintained as a single image (with provisions for background transparency) which is updated, or overlaid, with each foreground image demoted by the arrival of the next foreground image.

### BRIEF DESCRIPTION OF THE FIGURES

Referring now to the drawings which form a part of this original disclosure:

FIG. 1A-1D illustrate how a background image is overlaid with a foreground image and its sibling mask image to implement simple background transparency near the top of the region, along with cloud transparency near the bottom of the region.

FIG. 2A-2F extend the example in Figure group 1 to show an implementation of auto-shadowing and cropping transparencies.

### DETAILED DESCRIPTION OF THE PREFERRED EMBODIMENTS

The preferred embodiments of the present invention have been selected for their simplicity, specifically that all image preparation for these embodiments may be easily accomplished with widely used image-editing software such as consumer versions of PhotoShop.

### Public Specimens Utilizing the Java Language

The present invention may be implemented in any of a variety of computer languages, although the preferred embodiment emphatically specifies the Java computer language, being the only language with sufficient speed, compactness and wide distribution in web browsers. Java code, when executing within a browser, is organized as an entity known as an “Applet” and may be specified and started on a conventional web page using the HTML <APPLET> or <OBJECT> tag.

Numerous images rendered via such a Java embodiment have been placed in public view, approximately one month prior to the filing of this application, at the website www.ToonCat.com. Although these instances are seen there incorporated into a new computer language for web designers, still in its development phase, named “ToonCat”, the ToonCat language itself is actually implemented in the Java computer language, utilizing the Java Plug-in now bundled with most computer web browsers.

In fact, this preferred embodiment is compatible with the oldest version of Java found in web browsers, the so-called “Java-1” released in 1995 by Sun Microsystems, even though other aspects of the ToonCat language (e.g. its MP3 audio features) require “Java-2” or later versions.

Furthermore, the preferred embodiment at ToonCat.com will execute in older browsers which implement the now-obsolete Microsoft Virtual Machine (MVM), offered by the Microsoft corporation through 2004 as a Java-compatible language, with one performance degradation: Semi-transparency in the browser window appears as foreground stippling upon background, presumably as a strategy to increase processing speed of the MVM.

### GIF Image Format Preferred for Mask Image

As the preceding Summary had suggested, the preferred file format for the mask image is the so-called “GIF” format, also known as the “CompuServe GIF” format, because it is familiar in the public domain, because it is easily manipulated in consumer image editors, and most importantly because it provides for designating a special value for transparent pixels.

This designation of a transparency pixel is not required by the present invention, but experience has shown its worth as a convenience to anyone composing mask images in an image editor. Specifically, this value should be used in place of the pure-blue mask pixels described in the preceding Summary. The pure-blue value was offered as a simpler abstraction which avoided any confusion between traditional GIF transparency and transparency implemented by the present invention.

Nonetheless, using the GIF transparency value in the mask pixels to designate the ultimate transparency or opacity of primary image pixels permits a web artist to overlay the mask image onto the primary image, in an off-line image editor such as PhotoShop, and see quite immediately what parts of the primary image will become transparent when mask and primary are subsequently combined in the browser.

### Browser-Native Alpha Transparency Preferred

There was no suggestion in the Summary as to how, exactly, colors should be blended from two pixels where one overlays the other with a semi-transparency specified by their pertinent pixel in the mask image. It is understood that, in the Java context, the 32-bits-per-pixel format specifies that the 8 most significant bits comprise the “Alpha Channel”, such that a maximum value of 255 specifies full opacity, a minimum value of zero specifies full transparency, and all intermediate values specify some proportion of semi-transparency, but this disclosure has avoided specifying the details of how the colors specified in the lesser 24 bits should be blended according the Alpha values.

In early development, this invention used explicit blending algorithms in Java code to implement semi-transparency. In fact, this approach avoided the undesirable stippling effect mentioned earlier with the MVM.

Fortunately, this code has been made obsolete since 2004, as browsers were all outfitted with native abilities to process the Alpha bits more rapidly than could ever be achieved with explicit Java code. Thus images can now be sent to the browser window (e.g. from within Java's paint( ) method) with the underlying browser software assuring that the Alpha values will be utilized according to generally accepted standards.

The explicit-color blending code has been, accordingly, removed from the preferred embodiment, and the stippling is again seen with the (increasingly rare) MVM.

### Simple Transparency and Cloud-Transparency

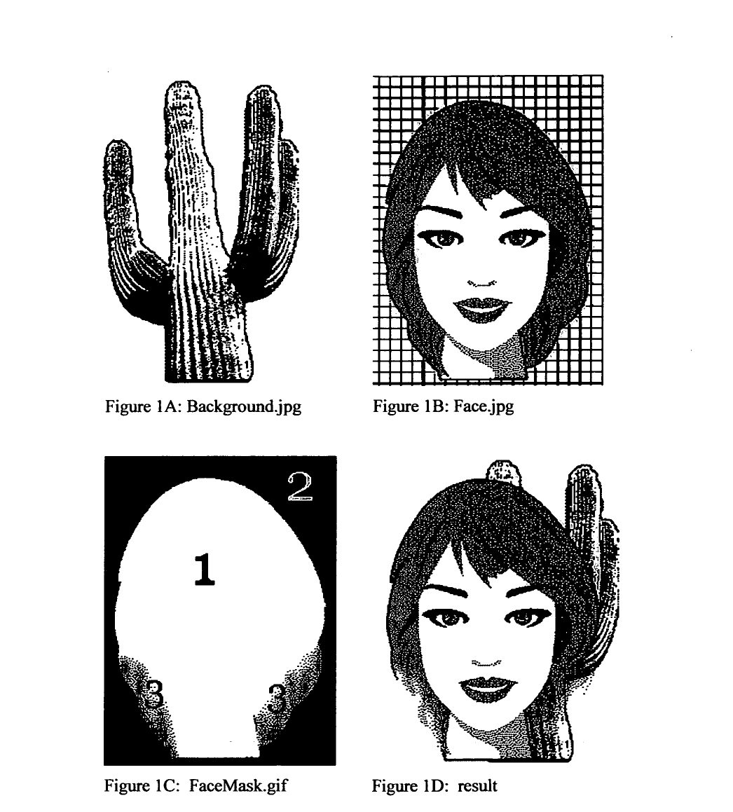

FIG. 1A represents a JPG image of a cactus against the desert sky, and this becomes the background image behind embodiments of both simple and cloud-transparency provided in the present invention, such that extraneous pixels in the JPG image in FIG. 1B (i.e. the grid pattern outside the boundaries of the woman's neck and hair) may be rendered as transparent so that cactus and woman may be displayed in the browser as shown in FIG. 1D with the realistic appearance of a woman actually standing in front of a cactus.

The realism of this simple transparency is further enhanced by the cloud-like, semi-transparent blending of the lower reaches of her hair with underlying pixels of cactus or sky, giving the natural effect of the actual way that hair, near the end of its strands, appears to be variably semi-transparent where it spreads apart freely into air.

Both of these effects are provided in this embodiment by the mapping of transparency attributes found in FIG. 1C. This sibling mask is conveyed by a conventional GIF image, and it contains three regions:

Region 1 holds the mask pixels which designate complete opacity for the corresponding pixels in 1B (namely the face and most of the hair). These mask pixels are pure-green, and the corresponding JPG pixels in 1B are accordingly set with an Alpha channel maximum value of 255.

Region 2 holds the pixels which designate complete transparency for the corresponding pixels in 1B (namely the unwanted grid-like pattern outside the central figure of 1B). These mask pixels hold the GIF file's transparency value, and the Alpha values of the corresponding JPG pixels in 1B are accordingly set to a minimum value of zero.

Region 3 comprises two zones which designate varying semi-transparency, referred to here as “cloud-transparency”. The pixels in this region are various shades of green, ranging from darkest green (red:0 green:1 blue:0) to brightest green (red:0 green:254 blue:0). These mask pixels designate varying Alpha values for their corresponding pixels in 1B. Standard color representation in browsers uses 8 bits for each primary color (red, green, blue) as well as for Alpha, and thus for example, a mask pixel of dark-green (red:0 green:87 blue:0) in this embodiment may conveniently designate an Alpha value of 87.

As mentioned earlier, the procedures described in this embodiment are implemented within a Java Applet, and according to Java convention, images contained within an Applet shall be copied to the browser's display window during calls to the Applet's paint( ) method, such calls originating from the browser's low-level software machinery. To achieve the desired transparency-overlay effect shown in FIG. 1D, code within the paint( ) method must first copy out the background image (FIG. 1A), and subsequently copy out the foreground image (FIG. 1B), to the same (X,Y) co-ordinates, with all pixel Alpha values set as described above. The mask image (FIG. 1C) is never copied out to the browser display.

The browser's internal software/hardware infrastructure uses the Alpha values of the display pixels in FIG. 1B to occlude, expose, or blend the color of each background pixel from FIG. 1A with the color of the overlaying pixel so as to achieve the desired transparency effects, FIG. 1D, at the browser window.

### Transparency Modes Using Near and Far Backgrounds

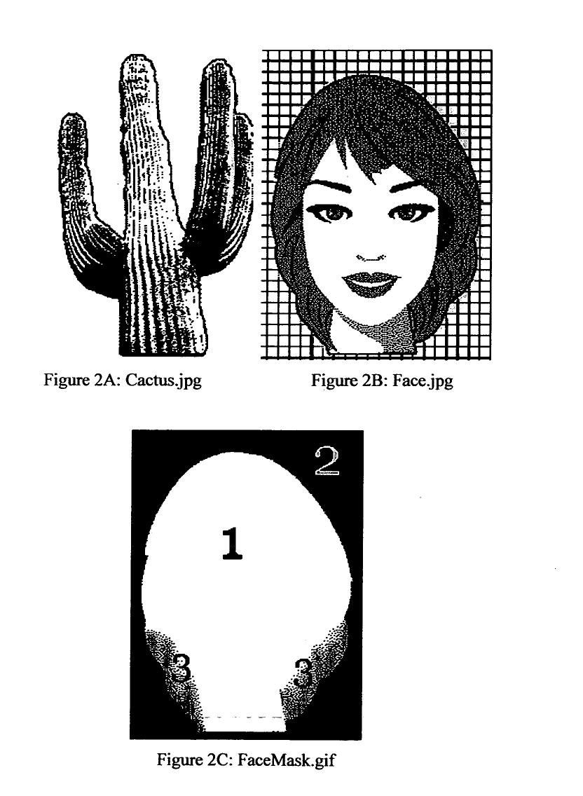

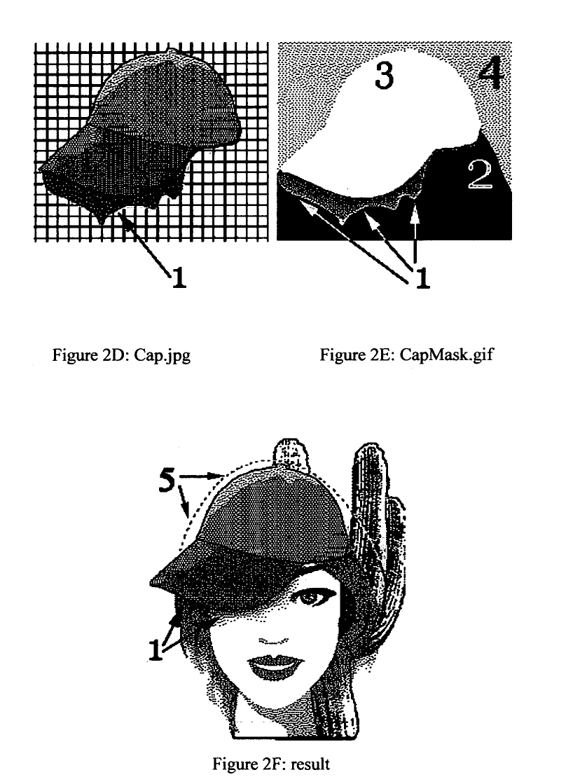

FIGS. 1A through 1D illustrated the simpler modes of transparency in this disclosure, wherein only a single background image was required for the desired realism. FIGS. 2A through 2F extend this description with the addition of an image of a baseball cap made to appear as if worn on the model's head, with its brim casting a shadow over her face, while her free-flowing hair appears constrained beneath the body of the cap.

In FIGS. 2A through 2C, the blending of pixel colors between background and foreground according to the mask image is identical to the processes described for FIGS. 1A through 1C. With the addition of the cap's image, FIG. 2D, plus the cap's sibling mask image, 2E, the entire composite will be processed further, notably by considering two different species of background image: The cactus image shown in FIG. 2A is now considered as “far” background, while the facial image shown in FIG. 2B (with its Alpha values adjusted according to the mask in FIG. 2C) is now considered as “near” background.

This dual background foundation is necessary for the enhanced realism offered by the present invention, namely auto-shadowing (whereby a shadow may be cast realistically by the cap's brim upon the woman's face but not unrealistically upon the cactus or sky); and also cropping-transparency (whereby a portion of the woman's hair becomes transparent to suggest that it has been compressed beneath the cap).

### Auto-Shadowing

Auto-shadowing, as described earlier, is a special case of cloud transparency requiring a means of forcing certain semi-transparent foreground pixels into 100% transparency wherever the background color is supplied entirely from far-background pixels. In FIG. 2D a swath of dark pixels in Region 1 will provide the appearance of a realistic shadow when these pixels are blended with the pixels of face and hair as specified by the corresponding mask pixels in Region 1 of FIG. 2E. The process is quite similar to the cloud-transparency embodiment already described, and by specifying decreased opacity of the darker foreground pixels furthest below the cap's brim, a more realistic effect is achieved, namely the softening of the shadow tone for parts of the face furthest from the solar occlusion of the cap.

Thus far, the brim shadow is an effect of the cloud-transparency previously described, but to complete the realism, the auto-shadowing process imposes a novel constraint: That the dark pixels in Region 1 shall be made totally transparent (i.e. their Alpha values set to zero) wherever they overlay pixels of far background (cactus or sky in FIG. 2A) which are not occluded by near background pixels in FIG. 2B. While pixels of face and hair in FIG. 2B occlude the far background in 2A, those pixels rendered transparent in 2B (i.e. as controlled by mask pixels in Region 2 in FIG. 2C), no longer occlude the underlying far background pixels, and thus the auto-shadowing process provides that the far background pixels shall be displayed with no color blending to the dark pixels in Region 1 of the foreground image in FIG. 2D (i.e. Alpha values for those dark pixels will be set to zero).

For simplicity of illustration, the cap's mask image includes no general cloud-transparency, but in practical applications it is expected that both general cloud-transparency and auto-shadowing should be controllable within the same mask image. Thus, means are needed to specify either or both modes within any mask pixel. For GIF mask images, it has proven most convenient to allow that any red value between 1 and 254, inclusive, may be attached to a mask pixel already specifying cloud-transparency (i.e. a green value between 1 and 254, inclusive).

Unlike the green values specifying cloud-transparency, however, there is nothing proportional about effect of the red values: Auto-shadowing is either inactive (i.e. red=0) or else it is active (i.e. 0<red<255). In this embodiment, the maximal red value of 255 is reserved for designating cropping transparency described below.

### Cropping Transparency

The auto-shadowing previously described co-exists with simple transparency and with cropping transparency in the figure of the baseball cap in FIGS. 2D and 2E. (The simple transparency, similar to that earlier described with FIGS. 1A through 1C, is specified by mask pixels in Region 2 of the mask image, FIG. 2E, having the transparency value designated for the GIF file. The simple opacity of cap, itself, is likewise specified by pure-green mask pixels in Region 3 of the mask image in FIG. 2E.)

Cropping transparency is provided in the final browser display, portrayed in FIG. 2F, as a convenient and automated way to realistically pose a baseball cap on a head of loose, full hair: Rather than requiring application to replace the primary face, FIG. 2B, with re-shaped hair appearing to be squeezed under the cap, a credible effect is achieved by cropping some of the pixels of the uppermost hairline (i.e. forcing them to be transparent). The effect is completed by some additional cropping of hair below the right-hand side of the cap, causing the hair to flair downward and outward from below the compressing illusion of the cap.

Thus in this embodiment, the cropping transparency is specified by mask pixels in Region 4 of FIG. 2E. These mask pixels have the maximum red value of 255, and because cropping transparency is either completely active or completely inactive, the blue or green values may be ignored for these pixels. This disclosure provides that there may be cases where the blue and green values could be exploited to specify further variations of cropping transparency not in this embodiment, but nonetheless claimed herein.

As with simple transparency, the corresponding Alpha values of the cropped primary display pixels in FIG. 2D are set to zero, and to complete the desired cropping effect, the Alpha values of corresponding display pixels in the near-foreground image, FIG. 2B, are likewise set to zero, causing an upper region of hair to be cropped within the broken line, 5.

The copy-out process of the Java Applet's paint( ) method is similar to what was disclosed for simple transparency: The software must first copy the far-background cactus image, FIG. 2A, to the browser display, followed by copy-out of the near-background facial image, FIG. 2B. Lastly, the foreground image, FIG. 2D, is copied out. Neither of the mask images, FIG. 2C and FIG. 2E, are copied out. The browser's native processing of the Alpha values within these three images, when conducted in this sequence, will accumulate to effect the realism of the combined modes of simple transparency, cloud transparency, auto-shadowing and cropping transparency.

### Enhancement for Pointing Function of a Computer Mouse

We have described how a mask image of a traditional format (typically GIF) can be used to enhance the rendering of its sibling (typically JPG), after which the mask's pixel array might normally be discarded into the browser's memory pool for re-use.

There is, however, a reason to retain these individual mask images for as long as their displayable siblings are retained: These mask images provide compact records of the opaque regions within the overlaid displayable images, due to the fact GIF images utilize a mere 8 bits per pixel (or less) compared to the 24 or 32 bits per pixel required for full-colored, display-ready storage in browser memory.

These compact maps of the original opaque regions in discrete foreground images can be essential for allowing a user's computer mouse to click-designate a particular item in a tightly packed group of images, an essential feature for a web garment-retailing application.

Consider the example of a mannequin overlaid, or “dressed” with various images of lingerie, garments, jewelry and outerwear. The resulting picture in the browser may show only small corners, straps or pieces of the various items, and yet we would wish that the user could designate any single item via a mouse-click on any of its visible pixels, even if most of this item appears to be obscured by other items overlaying it.

There is no efficient means for recording whether a foreground pixel is opaque or transparent in displayable JPG images. Furthermore, to conserve memory, the displayable images are often merged together as new ones arrive. Thus the only practical means for software to determine that a shopper is clicking on, for example, a bikini's thin shoulder strap is to map the click co-ordinates against the appropriate pixels in the retained mask images, starting with the topmost (i.e. most recently arrived) mask. If the bikini's shoulder strap were visible and accurately clicked, then one of the bikini's mask pixels designating opaque foreground would be the first such pixel to match the click co-ordinates in a downward search of the group of mask images.

### Brief Survey of Additional Embodiments

The preceding disclosure, while limited for simplicity of illustration, anticipates a variety of other embodiments of this invention. To wit:

Although there is often a one-to-one marking correspondence between the primary image and its sibling mask image, various mapping schemes may be used. For instance, if these two images were rendered in different magnifications, then the marking correspondence would be more dynamic, such as a many-to-one or a one-to-many correspondence between sibling pixels in these two images.

A further innovation here is the marking of attributes other than those for transparency. Other attributes which could be marked via the mask image include
1. Shimmer areas—as seen in a desert heat mirage or upon the reflecting surface of rippling water.
2. Phosphorescent areas—as would be specially illuminated by ultraviolet light.
3. Frost areas—as would whiten to suggest a gradual process of freezing.

Furthermore, this invention is not limited to using JPG as the primary image format nor GIF as the mask format. Other candidates for primary image could be the widely-used PNG, BITMAP or TIFF formats. Likewise, a mask image in this invention could be implemented via JPG, PNG, BITMAP or TIFF formats, although these are less size-efficient than the GIF format for use as masks.

What is claimed is:

1. A system for displaying an image in a standard web browser, derived from two data files, downloaded from a web server and then re-combined in a software algorithm executed at the browser, wherein one of said files provides a principal display image and the other file provides a mask image of pixel-encoded attributes to be applied to the pixels of the principal image by a mapping algorithm.

2. Means for display, according to claim 1, to include rendering of total transparency or of semi-transparency with respect to underlying images, said transparency being variable from pixel to pixel according to data contained in the mask image and mapped to the overlaid, displayed image.

3. Automatic shadow generation upon background images by means of semi-transparent dark regions in a foreground image, according to claim 2, with the auto-shadow attribute mapped to said dark pixels by the foreground mask image, such that the dark foreground pixels are blended semi-transparently with pixels of near-background, but are rendered as completely transparent against pixels of far-background.

4. Cropped transparency, effected by a foreground image overlaying an image of near background and an image of far background, according to claim 3, comprising the erasure from display of near-background pixels, and the promotion to display of underlying far-background pixels as specified by values in the mask-pixels of the foreground image.

5. Exploitation of pixel-encoded attributes, according to claim 1, to determine the final target image under a computer mouse-click, processed by an interactive computer-driven display, where various principal images with various transparent regions are overlaid on one another with overlapping boundaries, whereby said final target is determined by consideration of the transparency attributes specified in the various mask images, as mapped against the co-ordinates of the mouse-click.
